(19) United States
(12) Patent Application Publication
(10) Pub. No.: US 2022/0004849 A1
(43) Pub. Date: Jan. 6, 2022

(54) IMAGE PROCESSING NEURAL NETWORKS WITH DYNAMIC FILTER ACTIVATION

(71) Applicant: Google LLC, Mountain View, CA (US)

(72) Inventors: Zhourong Chen, Guangzhou (CN); Yang Li, Palo Alto, CA (US); Samuel Bengio, Los Altos, CA (US); Si Si, San Jose, CA (US)

(21) Appl. No.: 17/295,561

(22) PCT Filed: Nov. 20, 2019
(86) PCT No.: PCT/US2019/062455

§ 371 Date: May 20, 2021

Related U.S. Application Data
(60) Provisional application No. 62/770,120, filed on Nov. 20, 2018.

(51) Int. Cl. G06N 3/04; G06N 3/08; G06T 5/20; G06T 5/00

(52) U.S. Cl. CPC G06N 3/0454; G06N 3/084; G06T 2207/20081; G06T 5/002; G06T 2207/20084; G06T 5/20

(57) ABSTRACT

Methods, systems, and apparatus, including computer programs encoded on computer storage media, for processing images using neural networks. One of the methods includes receiving a network input; processing the network input through a gater neural network to generate a gating vector that includes a respective value for each of a plurality of filters; determining, from the gating vector and for each of the plurality of filters, whether the filter is active or inactive; and processing the network input through the main convolutional neural network to generate an image processing output, comprising, for each convolutional layer in the first plurality of convolutional layers: receiving an input feature map for the convolutional layer; and generating an output feature map, the generating comprising: for each filter of the convolutional layer that is inactive: setting the output channel for the filter to have all zero elements.

### CROSS-REFERENCE TO RELATED APPLICATION

This application claims priority to U.S. Patent Application No. 62/770,120, filed Nov. 20, 2018, the entirety of which is herein incorporated by reference.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that processes a network input that includes one or more images to generate an image processing output for an image processing task.

Particular embodiments of the subject matter described in this specification can be implemented so as to realize one or more of the following advantages.

The described techniques allow for input-dependent filter selection by augmenting a main neural network with a gater neural network that generates gating vectors that define which filters of the main neural network should be active for any given network input. By augmenting the main neural network with this input-dependent selection, the performance of the main neural network on a variety of tasks, e.g., image classification or object detection, can be improved relative to the performance of the main neural network if all filters are active for processing every network input, i.e., without being augmented with the gater neural network. More specifically, these additional performance gains are realized at least in part because the gater neural network generates the gating values for all of the filters globally, i.e., based on a shared global view of the entire network input. In other words, the gater neural network is provided with the same network input as the main neural network and uses this same network input to make a global decision for all of the filters in the main neural network. Additionally, this improvement can be realized with minimal computational overhead, i.e., with only minimal increases in computational complexity and resource consumption, e.g., processing power and memory consumption. In particular, the gater neural network can have many fewer parameters than the main neural network (in some cases even only on the order of 1% of the parameters of the main neural network). Thus, significant increases in performance can be realized without a corresponding significant increase in resource usage.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example image processing system.

FIG. 2 illustrates the main neural network and the gater neural network.

FIG. 3 is a flow diagram of an example process for processing a network input to generate an image processing output.

FIG. 4 is a flow diagram of an example process for training the main neural network and the gater neural network.

Like reference numbers and designations in the various drawings indicate like elements.

### DETAILED DESCRIPTION

This specification describes a system implemented as computer programs on one or more computers in one or more locations that processes a network input that includes one or more images to generate an image processing output for an image processing task.

For example, the image processing task can be image classification, where the image processing output is a set of scores, each score corresponding to a different object class and representing the likelihood that the one or more images depict an object belonging to the object class.

As another example, the image processing task can be object detection, where the image processing output identifies one or more regions in the one or more images and, for each region, a likelihood that region depicts an object of interest.

As another example, the image processing task can be image segmentation, where the image processing output defines, for each pixel in the one or more images, a respective likelihood for each category in a predetermined set of categories. For example, the set of categories can be foreground and background. As another example, the set of categories can be object classes.

As another example, the image processing task can be depth estimation, where the image processing output defines, for each pixel in the one or more images, a respective depth value.

As another example, the image processing task can be motion estimation, where the network input includes multiple images, and the image processing output defines, for each pixel of one of the input images, a motion of the scene depicted at the pixel between the images in the network input.

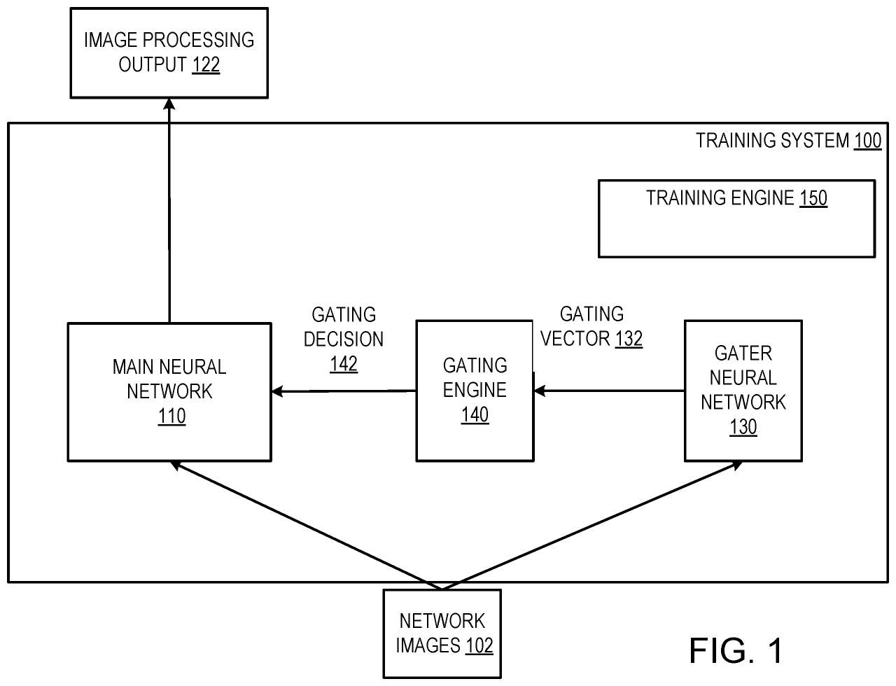

FIG. 1 shows an example image processing system 100. The image processing system 100 is an example of a system implemented as computer programs on one or more computers in one or more locations in which the systems, components, and techniques described below are implemented.

The system 100 receives a network input 102 that includes one or more images that include pixel data and processes the pixel data of the one or more images to perform the image processing task, i.e., to generate an image processing output 122 for the image processing task.

In particular, the system 100 generates the image processing output 122 for the image processing task by processing the network input 102 through a main convolutional neural network 110 (also referred to as a “backbone” neural network).

The main neural network 110 is a convolutional neural network that is configured to process network inputs to generate an image processing output for the image processing task for each received network input. Generally, the main neural network 110 can have any appropriate convolutional neural network architecture that allows the neural network 110 to generate the appropriate type of output for the image processing task.

In particular, the main neural network 110 includes multiple convolutional neural network layers and each convolutional layer has a respective set of filters.

More specifically, each convolutional layer is configured to receive as an input an input feature map, e.g., a set of two-dimensional feature maps concatenated along the depth dimension, and to generate an output feature map that includes a respective output channel, i.e., a respective output two-dimensional feature map, for each of the filters of the convolutional layer. In other words, the output of a given convolutional layer is a concatenation of output channels, each channel corresponding to a different filter. To generate the output channel for a given filter, the convolutional layer performs a convolution between the given filter and the input feature map for the layer. Some or all of the convolutional layers may then apply an element-wise non-linear activation function to the output feature map to generate the final output of the layer.

In other words, conventionally the final output of a convolutional layer/in the main neural network 110 would be expressed as:

Oᵢ^{l}(x)=ϕ(Fᵢ^{l}*I^{l}(x)),

where x is the network input, Oᵢ^{l}(x) is the i-th channel of the final output of the layer l, ϕ(.) is the activation function, Fᵢ^{l} is the i-th filter of the layer l, * denotes convolution, and I^{l}(x) is the input feature map to the layer l.

Which feature map each convolutional layer receives as input is defined by the architecture of the neural network 110. For example, when the architecture specifies that the layers in the neural network 110 are connected in sequence, each layer will receive as input the output feature map generated by the layer before that layer in the sequence.

For each network input 102, the system 100 dynamically determines, for at least some of the convolutional layers in the main neural network, which filters of the layer are active for the processing of the network input 102 and which filters are inactive. In other words, the system dynamically activates certain filters of the main neural network 110 for the processing of each network input. The activation of the filters is referred to as “dynamic” because it can be adjusted for each new network input 102 that is received by the system 100. In some cases, the main neural network 110 may include filters that are always active, i.e., cannot be deactivated by the system 100. In other cases, all of the filters of all of the main neural network may be under the control of the system 100.

In particular, the system 100 processes the network input 102 through a gater neural network 130. The gater neural network 130 is configured to process the network input 102 to generate a gating vector 132 that includes a respective value for each of the plurality of filters of each of a plurality of convolutional layers of the main neural network 110, i.e., for each of the filters that can be dynamically activated. If the main neural network 110 includes filters that are always active, the gating vector does not need to include values for the always active filters.

A gating engine 140 determines, from the gating vector 132 and for each of the plurality of filters of each of the first plurality of convolutional layers, whether the filter is active or inactive for the processing of the network input. In other words, the gating vector makes a gating decision 142 for each filter that determines whether the filter will be active or inactive for the processing of the network input 102.

The system 100 then processes the network input 102 through the main neural network to generate the image processing output 122. During the processing, for each filter of each convolutional layer that is active, the system performs a convolution between the input feature map and the filter to generate the output channel for the filter. For each filter that is inactive, the system sets the output channel for the filter to have all zero elements. In other words, when the system 100 can activate and deactivate filters of the layer l, the operations performed by the layer l satisfy Oᵢ^{l}(x)=ϕᵢ^{l}(Fᵢ^{l}*I^{l}(x)) when the filter l is active and Oᵢ^{l}(x)=0 when the filter l is inactive, where 0 is a feature map that has all values as zero.

Thus, the gater neural network 130 determines which filters should be active and inactive based on processing the same network input 102 as the main neural network 110. The gater neural network 130 also makes this determination globally for all of the filters in the main neural network 110 that can be dynamically activated. By making this decision globally and based on view of the entire network input, the gater neural network 130 can accurately determine which filters should be active in order to effectively process the network input 102 to generate a high quality output.

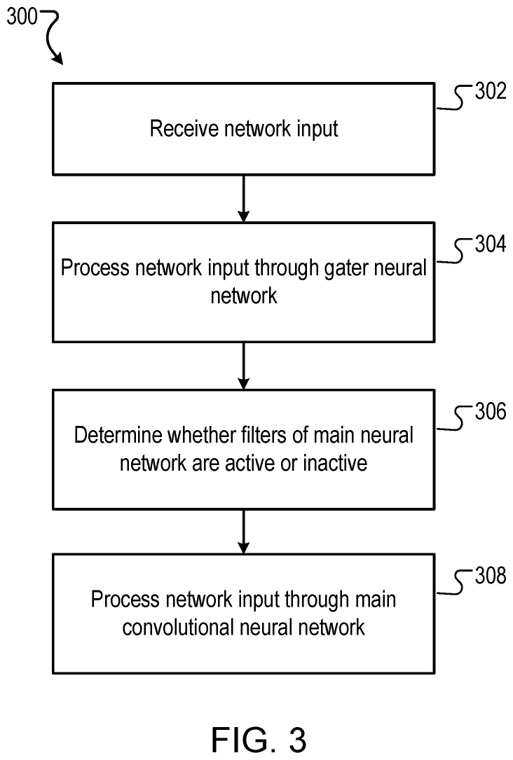

Determining which filters to make active and inactive is described in more detail below with reference to FIG. 3.

Generally, like the main neural network 110, the gater neural network 130 is a convolutional neural network. The gater neural network 130 can have any appropriate convolutional neural network architecture that allows the neural network 130 to map the network input 102 to a vector that has a respective value for each of the filters that can be dynamically activated. However, the gater neural network 130 can have many fewer parameters than the main neural network 110 (in some cases even only on the order of 1% of the parameters of the main neural network). In other words, because the gater neural network 130 only needs to generate the gating vector rather than the actual output of the image processing task, the gater neural network 130 requires only a “brief” view of the network input 102. By keeping the gater neural network 130 computationally efficient, the described dynamic filter selection scheme can be implemented with minimal additional computational overhead.

To allow the main neural network 110 to generate high quality image processing outputs, the training engine 150 trains the main neural network 110 and the gater neural network 130 jointly on a set of training data to determine trained values of the parameters of the main neural network 110 and the gater neural network 130.

The training data includes multiple training examples, with each training example including a training network input and a target image processing output for the training network input. The target image processing output for a given training network input is the output that should be generated by performing the image processing task on the training network input, i.e., that should be generated by the main neural network 110 by processing the training network input.

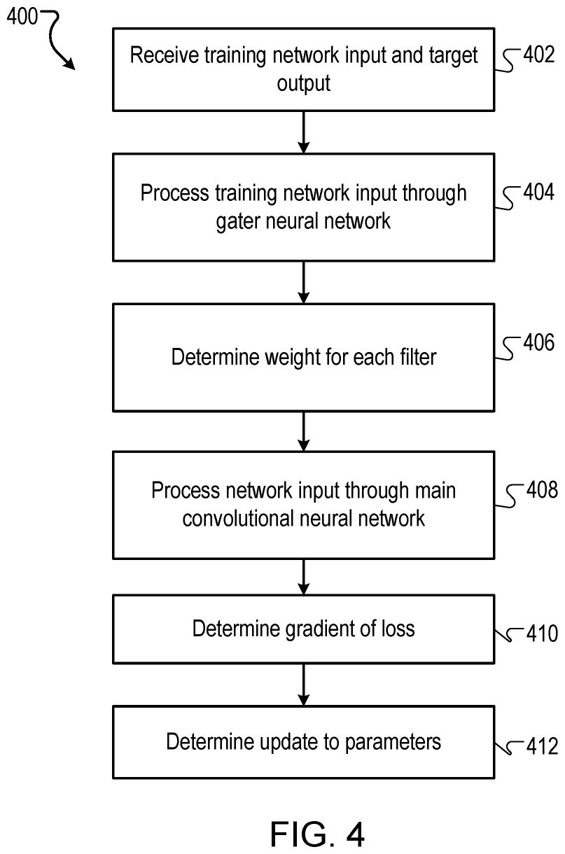

Training the neural networks is described in more detail below with reference to FIG. 4.

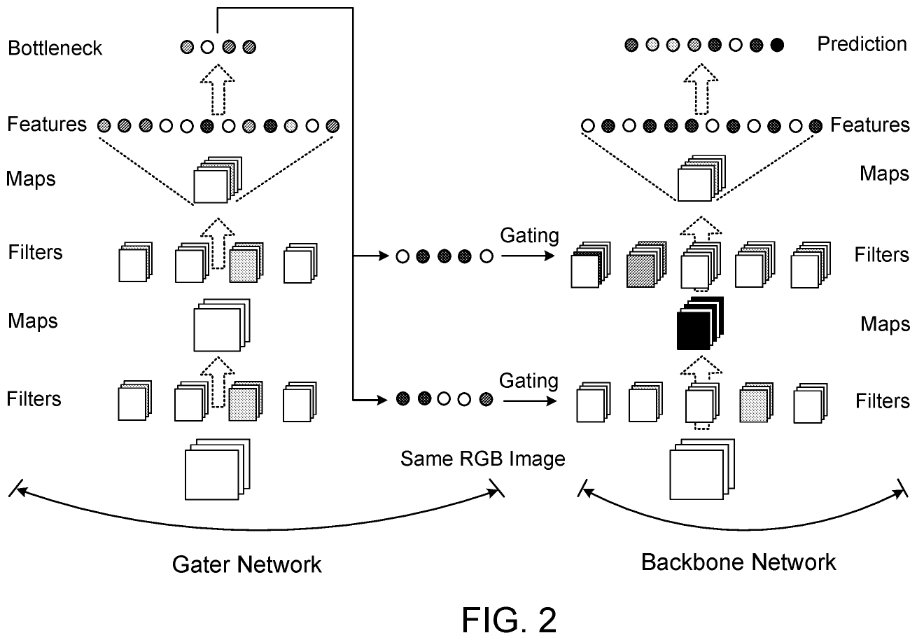

FIG. 2 shows the main neural network 110 (referred to in the Figure as a “backbone neural network”) and the gater neural network 130. In the example of FIG. 2, the network input includes a single RGB image.

The system processes the network input, i.e., the RGB image, through the gater neural network 130, which includes multiple convolutional layers. Each convolutional layer receives as input a set of input feature maps, and then applies a set of filters to the input to generate a set of output feature maps, with the last convolutional layer generating a vector f of size h. The neural network 130 then generates the gating vector from the vector f of size h using one or more fully-connected layers. In general, only a single fully-connected layer is required to transform the vector of size h to a vector of size c, where c is the number of filters that can be dynamically activated by the system. However, many convolutional neural networks have a large amount of filters, e.g., tens of thousands, and mapping the vector of size h to a vector of size c requires a projection weight matrix that has h×c parameters. This can be a very large number when h is thousands and c is tens of thousands. To reduce the number of parameters in this projection, the gater neural network 130 can instead use two fully-connected layers to fulfill the projection. The first layer projects f to a bottleneck of size b, followed by the second layer mapping the bottleneck to a vector of size c. In this way, the total number of parameters becomes (h+c)×b. This can be significantly smaller than h×c when b is much smaller than h and c.

The gating engine then uses the values in the gating vector to apply “gating” to certain filters of the main neural network 110. In other words, the gating engine determines, from the gating vector and for each of the plurality of filters of each of the first plurality of convolutional layers in the main neural network 110, whether the filter is active or inactive for the processing of the network input. The gating engine then sets to zero the elements of the output feature maps generated by those filters that are inactive.

The main neural network 110 then processes the RGB image to generate an image processing output (denoted as a “prediction” in FIG. 2) in accordance with the gating decisions made by the gating engine based on the output of the gater neural network 130.

FIG. 3 is a flow diagram of an example process 300 for processing a network input to generate an image processing output. For convenience, the process 300 will be described as being performed by a system of one or more computers located in one or more locations. For example, an image processing system, e.g., the image processing system 100 of FIG. 1, appropriately programmed, can perform the process 300.

The system receives a network input that includes one or more images (step 302).

The system processes the network input through the gater neural network to generate a gating vector that includes a respective value for each of the plurality of filters of each of the plurality of convolutional layers of the main neural network that can be dynamically activated (step 304). As described above, in some implementations, all of the convolutional layers of the main neural network can be dynamically activated and the gating vector therefore includes a respective value for each filter of each convolutional layer of the main neural network. In other implementations, some of the convolutional layers always have all of their filters active, and the gating vector therefore includes a respective value for each filter of only those convolutional layers of the main neural network that can be dynamically activated by the system.

The system determines, from the gating vector and for each of the plurality of filters of each of the plurality of convolutional layers, whether the filter is active or inactive for the processing of the network input (step 306).

In particular, the system can either (i) determine that each filter for which the respective value in the gating vector exceeds a threshold value is active and each filter for which the respective value in the gating vector does not exceed the threshold value is inactive or (ii) determine that each filter for which the respective value in the gating vector does not exceed a threshold value is active and each filter for which the respective value in the gating vector exceeds the threshold value is inactive.

The threshold value can be determined based on the range that the values in the gating vector can take. In implementations where the gating vector can include both negative and positive values, the threshold value can be zero.

The system then processes the network input through the main convolutional neural network to generate the image processing output (step 308).

During the processing, for a given convolutional layer in the main neural network, the system generates an output feature map for the convolutional layer that includes a respective output channel for each of the plurality of filters of the convolutional layer. For those filters that were determined to be active, the system performs a convolution between the input feature map and the filter to generate the output channel for the filter. For those filters that were determined to be inactive, the system sets the output channel for the filter to have all zero elements. The system can set the output channels for the inactive filters to zero by, for example, applying a mask to the output channels of the convolutional layer that multiplies all output channels corresponding to active filters by 1 and all output channels corresponding to inactive filters by 0.

By making discrete decisions about activation (as opposed to a soft attention over filters), the system can completely deactivate some filters for each input, and hence those filters will not be influenced by the irrelevant inputs. This may lead to training better filters than real-valued gates that are used for soft attention.

Additional, discrete decisions open the opportunity for model compression. In other words, by using discrete decisions, if certain filters are rarely active for a certain data set, the operations performed for those filters (and their corresponding parameters) can be pruned from the main neural network, increasing the computational efficiency of using the main neural network.

FIG. 4 is a flow diagram of an example process 400 for jointly training the main neural network and the gater neural network. For convenience, the process 400 will be described as being performed by a system of one or more computers located in one or more locations. For example, a image processing system, e.g., the image processing system 100 of FIG. 1, appropriately programmed, can perform the process 400.

In some implementations, the system can pre-train the main neural network, the gater neural network, or both before performing this joint training.

For example, the system can pre-train the main neural network on the image processing task with all of the filters of all of the convolutional layers active for all inputs.

As another example, instead of or in addition to pre-training the main neural network, the system can pre-train some or all of the layers of the gater neural network on the image processing task. To do this, the system can replace one or more final layers of the gater neural network with an output layer for the image processing task or add the output layer for the image processing task after the final layer in the gater neural network. After the pre-training, the system can remove the output layer from the architecture of the gater neural network.

The system can perform the process 400 for each training example in a mini-batch of training examples to generate a respective parameter update for each training example for both the main neural network and the gater neural network. For each of the neural networks, the system can then combine, e.g., average or add, the updates for the training examples in the mini-batch that were computed by that neural network and apply the combined update to the current values of the parameters of that neural network, e.g., by adding the combined update to the current values or subtracting the combined update from the current values.

By repeatedly performing this updating of the parameters across many mini-batches, the system repeatedly updates the parameters of the main neural network and the gater neural network to determine the trained values of the parameters of the main neural network and the gater neural network.

The system receives a training example (step 402) that includes a training network input and a target image processing output. The target image processing output is the output that should be generated by performing the image processing task on the network input.

The system processes the training network input through the gater neural network to generate a training gating vector (step 404).

The system determines, from the gating vector and for each of the plurality of filters of each of the first plurality of convolutional layers, a weight for the filter (step 406). Generally, to make the training more robust, the system introduces noise into the values in the gating vector and, so that the resulting weights can be used in the forward pass through the main network, maps the noisy values to a range between zero and one in order to generate the weights.

More specifically, for any given filter, the system applies noise to the value for the filter in the gating vector to generate a noisy value and applies a saturating sigmoid function to the noisy value to generate the weight. The system can generate the noise by sampling a value from a Gaussian distribution with mean 0 and standard deviation 1 or sampling from another appropriate distribution. This results in the weight for the filter being a value that is between zero and one, inclusive.

The system processes the training network input through the main convolutional neural network to generate a training image processing output (step 408).

The system can perform the processing of the network input differently for different training network inputs. In particular, activating and deactivating filters as is performed after training, i.e., as described in step 306 of the process 300 described above, is not a differentiable operation. Accordingly, the system cannot by default back-propagate the error through this “hard” decision in order to update the parameters of the gater neural network during training.

To account for this, for some training network inputs, the system (A) weights the output of the convolution performed with the given filter by the weight for the filter while, for other training inputs, the system (B) activates and deactivates filters based on the noisy values.

In particular, when processing inputs using (A), the system generates a training output feature map for a given convolutional layer by, for each filter of the convolutional layer, performing a convolution between the training input feature map and the filter to generate an initial output channel for the filter and applying the weight for the filter to the initial output channel for the filter to generate the output channel for the filter. In other words, the system weights the output of the convolution by multiplying each value in the output channel by the weight for the filter. Thus, no non-differentiable hard decisions are performed when processing inputs using (A).

When processing inputs using (B), the system determines, from the gating vector and for each of the plurality of filters of each of the first plurality of convolutional layers, whether the filter is active or inactive for the processing of the network input. The system then generates a training output feature map for a given convolutional layer by, for each filter of the convolutional layer that is active, performing a convolution between the training input feature map and the filter to generate the output channel for the filter; and for each filter of the convolutional layer that is inactive, setting the output channel for the filter to have all zero elements.

When processing inputs using (B), the system can determine which filters are active and which are inactive using a threshold as described above, except with the noisy values in place of the original values in the gating vector. That is, the system can either determine that each filter for which the respective noisy value exceeds the threshold value is active and determine that each filter for which the respective noisy value does not exceed the threshold value is inactive or vice versa.

The system can randomly select which network inputs are processed using (A) and which network inputs are processed using (B). For example, the system can randomly select half of the network inputs to be processed using (A) and randomly select half of the inputs to be processed using (B).

The system determines a gradient with respect to the parameters of the main neural network and the gater neural network of a loss function that includes one or more task-specific terms that measure a loss between the training image processing output and the target image processing output for the training network input (step 408).

The one or more terms can be any loss terms that are appropriate for measuring an error between two image processing outputs. For example, for classification tasks, these terms can be a cross-entropy loss. For regression tasks, these terms can be an L1 or L2 based per-pixel loss.

In some implementations, to prevent the gater neural network from activating an excessive number of filters for every network input, the loss function can also include a regularization term that encourages a sparse subset of the plurality of filters to be active during processing of any given network input after the joint training. For example, the regularization term can be based on an L1 norm of the gating vector, e.g., can be equal to the L1 norm of the gating vector divided by the total number of entries in the vector.

When the loss function includes this additional term, the overall loss function can be a sum or a weighted sum of the one or more task-specific terms and the regularization term.

For network inputs that were processed using (A), the system can directly back-propagate the gradients through into the gater neural network because no non-differentiable operation was performed.

For network inputs that were processed using (B), the system cannot by default back-propagate the gradient into the gater neural network because the decision of whether to make a filter active or inactive is not differentiable.

Instead, the system backpropagates a gradient of the weights for each of the filters into the gater neural network even though the weights were not directly used in the forward pass through the main neural network.

In other words, the system sets the gradient of the hard decision with respect to the noisy value to be equal to the gradient of the weight with respect to the noisy value. Because these gradients are assumed to be equal, the system can backpropagate the gradient of the weight with respect to the noisy value instead of the gradient of the hard decision.

The system determines, from the gradient, an update to the parameters of the main neural network and the gater neural network (step 410). The system can determine the update by applying an update rule to the gradient, e.g., a stochastic gradient descent update rule, an Adam optimizer update rule, an rmsProp update rule, or a learned update rule that is specific to the training of the neural networks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of processing a network input comprising one or more images through a main convolutional neural network to generate an image processing output for an image processing task, wherein the main convolutional neural network comprises a first plurality of convolutional layers each having a respective plurality of filters, and wherein the method comprises:
receiving the network input;
processing the network input through a gater neural network, wherein the gater neural network is configured to process the network input to generate a gating vector that includes a respective value for each of the plurality of filters of each of the first plurality of convolutional layers;
determining, from the gating vector and for each of the plurality of filters of each of the first plurality of convolutional layers, whether the filter is active or inactive for the processing of the network input; and
processing the network input through the main convolutional neural network to generate the image processing output, comprising, for each convolutional layer in the first plurality of convolutional layers:
receiving an input feature map for the convolutional layer; and
generating an output feature map for the convolutional layer that comprises a respective output channel for each of the plurality of filters of the convolutional layer, the generating comprising:
for each filter of the convolutional layer that is active:
performing a convolution between the input feature map and the filter to generate the output channel for the filter; and
for each filter of the convolutional layer that is inactive:
setting the output channel for the filter to have all zero elements.

2. The method of claim 1, wherein determining, from the gating vector and for each of the plurality of filters of each of the first plurality of convolutional layers, whether the filter is active or inactive for the processing of the network input comprises:
determining that each filter for which the respective value in the gating vector exceeds a threshold value is active; and
determining that each filter for which the respective value in the gating vector does not exceed the threshold value is inactive.

3. The method of claim 1, wherein determining, from the gating vector and for each of the plurality of filters of each of the first plurality of convolutional layers, whether the filter is active or inactive for the processing of the network input comprises:
determining that each filter for which the respective value in the gating vector does not exceed a threshold value is active; and
determining that each filter for which the respective value in the gating vector exceeds the threshold value is inactive.

4. The method of claim 2, wherein the threshold value is zero.

5. The method of claim 1, wherein the gater neural network comprises a plurality of convolutional layers configured to receive the network input and to process the network input to generate a feature vector and a plurality of fully-connected layers configured to receive the feature vector and to process the feature vector to generate the gating vector.

6. The method of claim 1, wherein the gater neural network and the main neural network have been trained jointly on training data for the image processing task.

7. The method of claim 6, wherein, during the joint training, the gater neural network is regularized to encourage a sparse subset of the plurality of filters to be active during processing of any given network input.

8. A computer-implemented method of jointly training a main convolutional neural network and a gater neural network, wherein:
the main convolutional neural network comprises a first plurality of convolutional layers each having a respective plurality of filters, the main convolutional neural network being configured to process a network input comprising one or more images to generate an image processing output for an image processing task, and
the gater neural network is configured to process the neural network input to generate a gating vector that includes a respective value for each of the plurality of filters of each of the first plurality of convolutional layers, the method comprising:
receiving a first plurality of training network inputs and, for each training network input, a target output for the image processing task; and
for each training network input in the first plurality:
processing the network input through the gater neural network to generate a training gating vector;
determining, from the gating vector and for each of the plurality of filters of each of the first plurality of convolutional layers, a weight for the filter;
processing the training network input through the main convolutional neural network to generate a training image processing output, comprising, for each convolutional layer in the first plurality of convolutional layers:
receiving a training input feature map for the convolutional layer; and
generating a training output feature map for the convolutional layer that comprises a respective output channel for each of the plurality of filters of the convolutional layer, the generating comprising:
for each filter of the convolutional layer:
performing a convolution between the training input feature map and the filter to generate an initial output channel for the filter; and
applying the weight for the filter to the initial output channel for the filter to generate the output channel for the filter;
determining a gradient with respect to parameters of the main neural network and the gater neural network of a loss function that includes one or more terms that measure a loss between the training image processing output and the target image processing output for the training network input; and
determining, from the gradient, an update to the parameters of the main neural network and the gater neural network.

9. The method of claim 8, wherein the loss function includes a regularization term that encourages a sparse subset of the plurality of filters to be active during processing of any given network input after the joint training.

10. The method of claim 8, further comprising:
prior to the joint training, pre-training the main neural network with all filters active on the image processing task.

11. The method of claim 8, further comprising:
prior to the joint training, pre-training one or more of the layers of the gater neural network on the image processing task.

12. The method of claim 8, wherein determining, from the gating vector and for each of the plurality of filters of each of the first plurality of convolutional layers, a weight for the filter comprises;
applying noise to the value for the filter in the gating vector to generate a noisy value; and
applying a saturating sigmoid function to the noisy value to generate the weight.

13. The method of claim 8, further comprising:
receiving a second plurality of training network inputs and, for each training network input, a target output for the image processing task; and
for each training network input in the second plurality:
processing the network input through the gater neural network to generate a training gating vector;
determining, from the gating vector and for each of the plurality of filters of each of the first plurality of convolutional layers, a weight for the filter;
determining, from the gating vector and for each of the plurality of filters of each of the first plurality of convolutional layers, whether the filter is active or inactive for the processing of the network input;
processing the training network input through the main convolutional neural network to generate the image processing output, comprising, for each convolutional layer in the first plurality of convolutional layers:
receiving a training input feature map for the convolutional layer; and
generating an output feature map for the convolutional layer that comprises a respective output channel for each of the plurality of filters of the convolutional layer, the generating comprising:
for each filter of the convolutional layer that is active:
performing a convolution between the training input feature map and the filter to generate the output channel for the filter; and
for each filter of the convolutional layer that is inactive:
setting the output channel for the filter to have all zero elements;
determining a gradient with respect to parameters of the main neural network and the gater neural network of the loss function, comprising backpropagating a gradient of the weights for each of the filters into the gater neural network; and
determining, from the gradient, an update to the parameters of the main neural network and the gater neural network.

14. The method of claim 13, wherein determining, from the gating vector and for each of the plurality of filters of each of the first plurality of convolutional layers, a weight for the filter comprises;
applying noise to the value for the filter in the gating vector to generate a noisy value; and
applying a saturating sigmoid function to the noisy value to generate the weight.

15. The method of claim 14, wherein determining, from the gating vector and for each of the plurality of filters of each of the first plurality of convolutional layers, whether the filter is active or inactive for the processing of the training network input comprises:
determining that each filter for which the respective noisy value exceeds a threshold value is active; and
determining that each filter for which the respective noisy value does not exceed the threshold value is inactive.

16. The method of claim 8, wherein the main convolutional neural network further comprises a second plurality of different convolutional layers that are not in the first plurality.

17. The method of claim 1, wherein the main convolutional neural network further comprises a second plurality of different convolutional layers that are not in the first plurality.

18. (canceled)

19. A system comprising one or more computers and one or more storage devices storing instructions that when executed by one or more computers cause the one or more computers to perform operations for processing a network input comprising one or more images through a main convolutional neural network to generate an image processing output for an image processing task, wherein the main convolutional neural network comprises a first plurality of convolutional layers each having a respective plurality of filters, and wherein the operations comprise:
receiving the network input;
processing the network input through a gater neural network, wherein the gater neural network is configured to process the network input to generate a gating vector that includes a respective value for each of the plurality of filters of each of the first plurality of convolutional layers;
determining, from the gating vector and for each of the plurality of filters of each of the first plurality of convolutional layers, whether the filter is active or inactive for the processing of the network input; and
processing the network input through the main convolutional neural network to generate the image processing output, comprising, for each convolutional layer in the first plurality of convolutional layers:
receiving an input feature map for the convolutional layer; and
generating an output feature map for the convolutional layer that comprises a respective output channel for each of the plurality of filters of the convolutional layer, the generating comprising:
for each filter of the convolutional layer that is active:
performing a convolution between the input feature map and the filter to generate the output channel for the filter; and
for each filter of the convolutional layer that is inactive:
setting the output channel for the filter to have all zero elements.

20. The system of claim 19, wherein determining, from the gating vector and for each of the plurality of filters of each of the first plurality of convolutional layers, whether the filter is active or inactive for the processing of the network input comprises:
determining that each filter for which the respective value in the gating vector exceeds a threshold value is active; and
determining that each filter for which the respective value in the gating vector does not exceed the threshold value is inactive.

21. The system of claim 19, wherein determining, from the gating vector and for each of the plurality of filters of each of the first plurality of convolutional layers, whether the filter is active or inactive for the processing of the network input comprises:
determining that each filter for which the respective value in the gating vector does not exceed a threshold value is active; and
determining that each filter for which the respective value in the gating vector exceeds the threshold value is inactive.
